(19) United States
(12) Patent Application Publication
(10) Pub. No.: US 2009/0327091 A1
(43) Pub. Date: Dec. 31, 2009

(54) LICENSE MANAGEMENT FOR SOFTWARE PRODUCTS

(75) Inventors: Amanda Anne Hartin, Duvall, WA (US); Sanjay Garg, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/147,394

(22) Filed: Jun. 26, 2008

(51) Int. Cl. G06Q 30/00; H04L 9/32

(52) U.S. Cl. 705/26; 726/28

(57) ABSTRACT

Technologies are described herein for software product license management. Following a click to run paradigm, manual user entry of product keys and manual user involvement in product activation may be avoided. A software product key can be associated with a user ID. The product key and associated user ID can be stored on a remote application server. The product key can be retrieved from the application server using the user ID or related user credentials. An application retrieving its own product key from the application server can be supported. The user-centric approach to product key management can be useful for software license models based on subscriptions, trial software, virtual software, downloadable software, or purely web based solutions as well as traditional software license purchases. The software product can also be autonomously activated. This activation can occur as a background operation within the application client portion of the software.

### BACKGROUND

Traditionally, when a software product is purchased, a product key for the software is also provided. The product key is typically a long string of numbers, letters, or both. For example, many product keys are a twenty-five digit “five-by-five” alphanumeric key. To operate the software that was purchased, the product key may be properly entered by hand. Entry of the product key is typically requested during the installation or setup of software. Manually entered product keys may also be used when software is purchased electronically, or downloaded, even though the product key may be provided to the user as part of the electronic transaction to purchase the software.

A license to use a purchased software product is generally associated with the product key supplied at the time of purchase. A purchaser must retain the product key as a manifestation of the license to use the software product. For example, if the software is to be installed again in the future, there may be another prompting for entry of the product key. Since product keys are generally long strings of seemingly random numbers or alphanumeric symbols, the product key is not easily committed to memory. Retaining the product key typically involves retaining a physical print out or license certificate containing the product key.

In addition to manually entering the product key, many software licenses require a manual activation procedure. Such activation typically requires user approval to access a licensing server using the Internet or a dial-up telephone modem. Once a product key is entered during the installation, or first execution, of a software product, the user may be prompted to allow the software to be registered and activated. The user generally acknowledges this operation prior to the software product accessing the activation server over the Internet or over a telephone modem. This activation process generally involves verifying the product key to an activation server operated by the software manufacturer.

It is with respect to these considerations and others that the disclosure made herein is presented.

### SUMMARY

Technologies are described herein for software product license management. In particular, techniques for simplifying the purchase, delivery, installation, and activation of software products are described. Following a “click to run” paradigm, manual user entry of product keys and manual user involvement in product activation may be avoided. Through such automation, the customer may not ever need to deal with a product key. In fact, the customer may not even need to be aware of the existence of the product key. Use of the technologies discussed herein can reduce the complexity of software purchasing and installation towards a simple click and run operation for the end user or local administrator.

According to one aspect presented herein, a product key can be associated with a user identification (user ID) associated with the purchasing user. The product key and associated user ID can be stored on a remote application server. The product key can be stored to the application server at the time of purchasing the software product license. Since the product key can be associated with the user ID of the user, the license can be considered to be tied to the user instead of being tied to the machine where the software is installed. The user-centric approach to product key management can be useful for software license models based on subscriptions, virtual software, downloadable software, or purely web based solutions as well as various traditional software purchase paradigms.

According to another aspect presented herein, a product key can be retrieved from an application server. The retrieval can be based on a user ID or other user credentials. The retrieval can also involve specifying an identification of the respective software product. Other information such as the language, version number, or licensing type of the software product can also be provided to the application server when storing or retrieving the product key. An application can retrieve its own product key from the application server after prompting the user for their user ID. The product key may still be the same type of product key used in traditional license management systems. For example, the product key may be a five-by-five key. The automatic retrieval of the product key from the application server can obviate the traditional requirement for the user to manually enter in the product key. Instead, the user may use their user ID to identify themselves to the application server and thus prompt the application server to return the associated product key. The user may not even need to be aware of the product key. The user may only need to remember their user credentials, such as their user ID, a password, or other identifying information. The same user credentials may be used to retrieve product keys for multiple software products associated with a given user.

According to yet another aspect presented herein, software products can be automatically activated. This activation can occur as a background operation within the application client portion of the software. After retrieving its product key from an application server, an application client or other software product can activate itself against an activation server. This activation can occur autonomously without user intervention. The traditional prompting of a user to access the Internet or perform a telephone activation for registering or activating a software product can be avoided.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer network diagram illustrating a networked computer architecture capable of implementing aspects of an embodiment presented herein;

FIG. 2 is a functional block diagram illustrating various components of a software licensing management system according to aspects of an embodiment presented herein;

FIG. 3 is a logical flow diagram illustrating aspects of processes for managing licenses for software products according to aspects of an embodiment presented herein; and

FIG. 4 is a computer architecture diagram showing an illustrative computer hardware and software architecture for a computing system capable of implementing aspects of an embodiment presented herein.

### DETAILED DESCRIPTION

The following detailed description is directed to technologies for simplifying the purchase, licensing, delivery, installation, and activation of software products. Through the use of the technologies and concepts presented herein, a software product key can be associated with a user ID and stored on an application server. The remotely stored product key can be recovered by the application itself using credentials from the associated user without the user having to receive or enter the product key manually. Also, product activation can be carried out autonomously by the application as a background process. This may occur without user intervention.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for simplifying software license management by associating a product key with a user ID and storing the key to a remote application server.

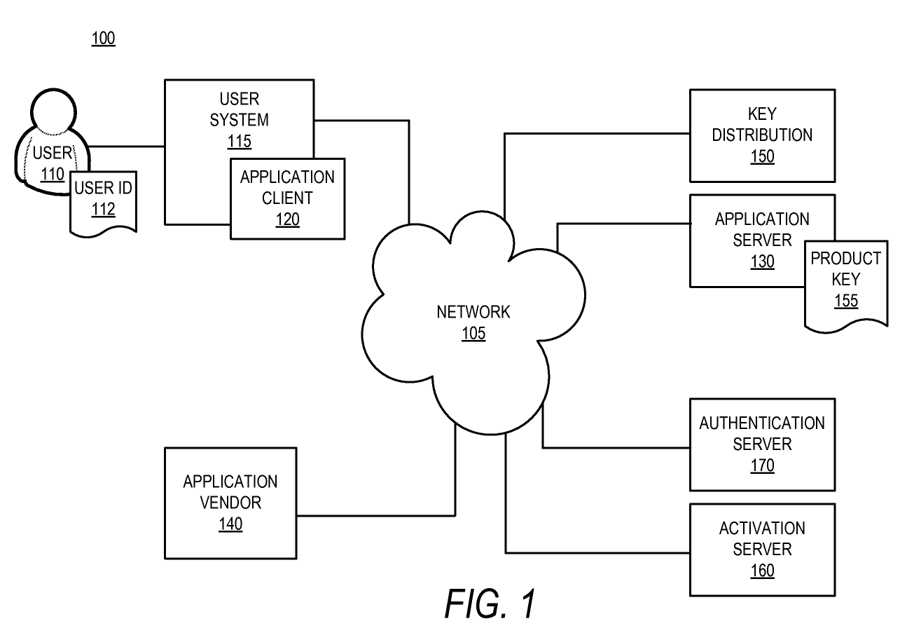

Turning now to FIG. 1, details will be provided regarding techniques for simplifying the purchase, delivery, installation, and activation of software products. In particular, a user 110 can operate a user system 115. The user system 115 can be a typical computer system, such as a desktop or a laptop. The user system 115 can also be an embedded computer system such as a handheld computer, a kiosk, a mobile terminal, a mobile telephone, a set top box, or any other type of computer system. The user system 115 can be attached to a computer network 105.

Through the computer network 105, the user 110 operating the user system 115 may access an application vendor 140. The user 110 may request purchase of application software from the application vendor 140. At the time of purchasing software from the application vendor 140, a product key 155 may be associated with the software product being purchased. The application vendor 140 may associate the product key 155 with a user ID 112 of the user 110. This associated product key 155 and user ID 112 may be stored on an application server 130 by the application vendor 140. Prior to storing the product key 155 on the application server 130, a key distribution server 150 may have been accessed to supply the product key 155 to the application vendor 140.

An application client 120 may be downloaded over the network 105 to the user system 115 after the user 110 purchases the software product, or license, from the application vendor 140. The application client 120 may be executed upon the user system 115. Upon the first execution, the user 110 may be prompted to enter their user ID 112 and other credentials such as a password or information associated with the user 110. This user information may be used by the application client 120 to retrieve the product key 155 from the application server 130 over the network 105. Automatic retrieval of the product key 155 by the application client 120 can replace the traditional manual entry of the product key 155.

At any point where the user 110 is requested to supply their credentials, such as their user ID 112, the user's information can be authenticated against an authentication server 170. Such authentication can support verification that the user is who they claim to be.

As part of the initial execution of the application client 120, the software application may be activated using the activation server 160 over the network 105. The activation procedure may be carried out by the application client 120 as a background process. This autonomous activation of the application software by the application client 120 can replace the traditional operation of manual activation that typically involved user intervention.

The user system 115, the key distribution server 150, the application server 130, the authentication server 170, the activation server 160, and servers associated with the application vendor 140 may all be computer systems. Some of these computer systems may involve components in common, or may be co-located. For example, the key distribution server 150, the application server 130, the authentication server 170, the activation server 160, servers associated with the application vendor 140, or any subset thereof may by operated by the software manufacturer. In another example, the application vendor 140 may be a third party operating with the authority of the software manufacturer, or as a retail distribution affiliate of the software manufacturer. In yet another example, the authentication server 170 may be operated by a third party security provider.

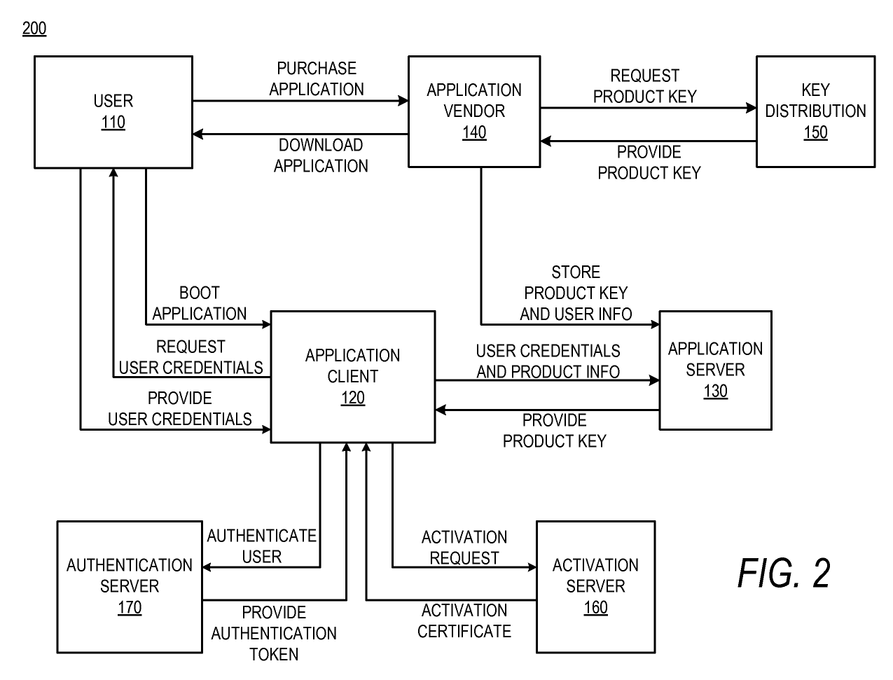

Turning now to FIG. 2, additional details will be provided regarding techniques for simplifying the purchase, delivery, installation, and activation of software products. In particular, a functional block diagram illustrates various components of a licensing management system 200 for software products according to aspects of an embodiment presented herein. A user 110 can initiate the purchase of application software from an application vendor 140. In response to the purchase of application software, the application vendor 140 can request a product key 155 from a key distribution server 150. In response, the key distribution server 150 can provide a product key 155 to the application vendor 140. The application vendor 140 can associate the product key 155 with information related to the purchasing user, such as a user ID 112. The application vendor 140 can cause the associated product key 155 and user ID 112 to be stored at an application server 130.

After the product key 155 has been obtained and properly stored, the application client 120 associated with the software being purchased can be downloaded from the application vendor 140 to the user system 115. The application client 120 downloaded at the time of purchase can be a low impact software module that is a reduced version of a full application client 120. According to one embodiment, the downloaded module may provide an icon, shortcut, or other mechanism for launching the purchased application, along with a bootstrapping mechanism for obtaining remaining modules of the full application client 120 as needed. The downloaded low impact module can also contain the functionality for obtaining the product key 155 and also for authenticating the user 110 and activating the purchased software against an activation server 160. As such, a downloaded low impact module can support the technologies discussed herein for simplifying the purchase, delivery, installation, and activation of software products.

After an application client 120 has been delivered to a user system 115, the user 110 can execute the application client 120. Upon the first execution of the application client 120, the user 110 may be prompted by the application client 120 to enter their user credentials. The user credentials can include a user ID 112, a user password, and other information associated with the user. In response to this request, the user 110 can provide their user credentials to the application client 120. The application client 120 can authenticate the user credential information against an authentication server 170. The authentication server 170 can provide an authentication token to the application client 120.

Once the application client 120 has authenticated the user 110 to be who they claim to be, the application client 120 can pass the user credentials, or a related authentication token, to an application server 130. At the same time, the application client 120 can also pass along product information associated with the application client 120. The product information may include an identifier of the application that was purchased, the version number, language, license type, and so forth. The application server 130 can use the information provided to it by the application client 120 to locate the product key 155 that was previously stored to the application server 130. The application server 130 can provide the product key 155 associated with the application client 120 and the user 110 to the application client 120. Thus, the application client 120 may retrieve its own product key 155 from the application server 130. This retrieval may be based upon the user ID 112 of the purchasing user.

The application client 120 can submit an activation request to an activation server 160. This activation procedure can occur as a background operation of the application client 120. In response to receiving an activation request from the application client 120, the activation server 160 can provide activation to the application client 120. The activation may take the form of an activation certificate. This functionality can support autonomous activation, by the application client 120, of the software applications associated with the application client 120. This activation can be performed, in the background, without the traditional intervention of the user 110. It should be appreciated that the activation exchange with the activation server 160 may also involve, or be performed by, the application server 130.

According to one embodiment, a software licensing system 200 may be used for purchasing MICROSOFT OFFICE office automation software from MICROSOFT, CORPORATION. For example, MICROSOFT OFFICE Version 14 may use software license management technologies discussed herein. Using these technologies can support purchase, product key 155 provisioning, and activation of MICROSOFT OFFICE using an online application vendor 140. A user 110 can request to purchase MICROSOFT OFFICE from an application vendor 140. According to one embodiment, the application vendor 140 may be DIGITAL RIVER, INCORPORATED. During the online purchase procedure, the user 110 may be requested to enter their user ID 112 to the application vendor 140. In this example, the user ID 112 may be a WINDOWS LIVE ID (WLID) associated with the user 110. Identification information supplied by the user 110, including their user ID 112, may be authenticated against an authentication server 170.

During an online software purchase operation for MICROSOFT OFFICE, the user 110 may specify a specific flavor of MICROSOFT OFFICE that they are interested in purchasing. One example of a specific flavor of MICROSOFT OFFICE may be a trial version that may allow the user to try the software prior to making a purchase. In such an example, the product key 155 provided may be a time limited key supplied without payment. Another example of a specific flavor may be a permanent license version of MICROSOFT OFFICE. Such a permanent license may be considered to be similar to a traditional license as supplied when purchasing the boxed CD-ROM version of a software package. Yet another specific flavor of MICROSOFT OFFICE may be a temporary subscription. For example, a temporary subscription may involve a product key 155 lasting a term of one year, or some other amount of time. In all of these cases, the specific product key may be requested by the application vendor 140, such as DIGITAL RIVER, from a key distribution system 150. In this example, the key distribution system may be a MICROSOFT SELLKEYS server operated by MICROSOFT CORPORATION.

Once a product key 155 is issued from a key distribution server 150, the application vendor 140 may support download of the selected flavor of the application client 120, or MICROSOFT OFFICE client, according to one example. During this purchase procedure, the user 110 may not have a product key 155 explicitly provided to them. Instead, the application vendor 140 may pass the product key 155 acquired from the key distribution server 150 on to the application server 130. At the application server 130, the product key 155 may be associated with the user ID 112 of the user 110. In this example, the application server 130 may be an OFFICE LIVE server operated by MICROSOFT, CORPORATION. In association with the OFFICE LIVE server, the user ID 112 may take the form of a WLID. The product key 155 may be stored on the OFFICE LIVE server so as to allow retrieval based upon the user ID 112, or WLID, of the user 110. The OFFICE LIVE server may store product keys 155 for multiple software application in association with each user ID 112 or WLID.

Once the downloaded MICROSOFT OFFICE product has been delivered to the user system 115, the user 110 can execute the MICROSOFT OFFICE client as the application client 120. During initial execution of the MICROSOFT OFFICE client, the user 110 may be requested to enter user credentials. These user credentials can include a user ID 112, WLID, or other user related information. The MICROSOFT OFFICE client may authenticate the user credential information against an authentication server 170. In this example, the authentication server 170 may be a WINDOWS LIVE server where the WINDOWS LIVE server is capable of authenticating a WLID provided by a user 110. In another example, the authentication server 170 can be the authentication server associated with the HOTMAIL email system from MICROFT CORPORATION, or the DOT-NET Internet services from MICROSOFT CORPORATION.

After successfully authenticating the user 110, the application client 120, or in this example the MICROSOFT OFFICE client, may pass an authentication token to an application server 130 such as the MICROSOFT OFFICE LIVE server. The application client 120 may also pass specific information regarding the software product being used to the OFFICE LIVE server. This specific information can include the version of the software product, the language of the software product, such as English, Japanese, French, or Spanish, or so forth. In response, the application server 130, or in one example the OFFICE LIVE server, may supply a product key 155 to the application client 120. As discussed, the application client 120 can perform an activation request against an activation server 160 and receive an activation certificate. This activation process can occur in the background without manual intervention of the user 110.

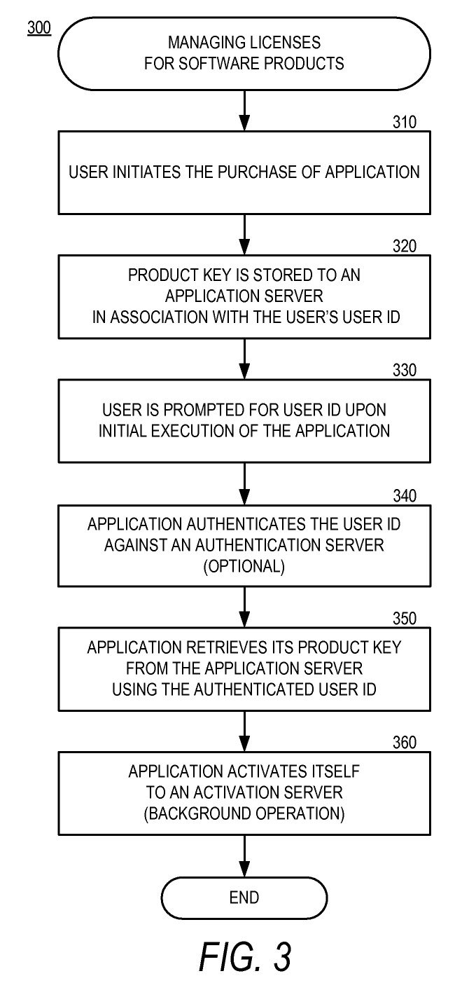

Referring now to FIG. 3, additional details will be provided regarding the embodiments presented herein for simplifying the purchase, licensing, delivery, installation, and activation of software products. In particular, FIG. 3 is a flow diagram illustrating aspects of a process 300 for managing licenses associated with software products.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as state operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed sequentially, in parallel, or in a different order than those described herein.

The routine 300 begins at operation 310, where a user 110 can initiate the purchase of an application software license from an application vendor 140. At operation 320, a product key 155 can be associated with a user ID 112 of the user 110. The associated user ID 112 and product key 155 pair may then be stored to an application server 130 by the application vendor 140. At the time of purchase of the software product license, the product key 155 can be obtained by the application vendor 140 from the key distribution server 150.

At operation 330, the application client 120 can prompt the user 110 to enter their user credentials, such as their user ID 112. The request for user credentials can occur when the user 110 executes the application for the first time. These user credentials can include a user ID 112, a password, other user information, or any combination thereof. At operation 340, the application client can authenticate the user ID 112 obtained in operation 330 against an authentication server 170. The authentication procedure is optional.

At operation 350, the application client 120 can retrieve its product key 155 from the application server 130. The product key 155 can be retrieved using the authenticated user ID 112 as obtained from the user 110 in operation 330. At operation 360, the application client 120 can activate itself autonomously to an activation server 160 as a background operation. This background operation can occur without manual intervention from the user 110. The routine 300 can terminate after operation 360.

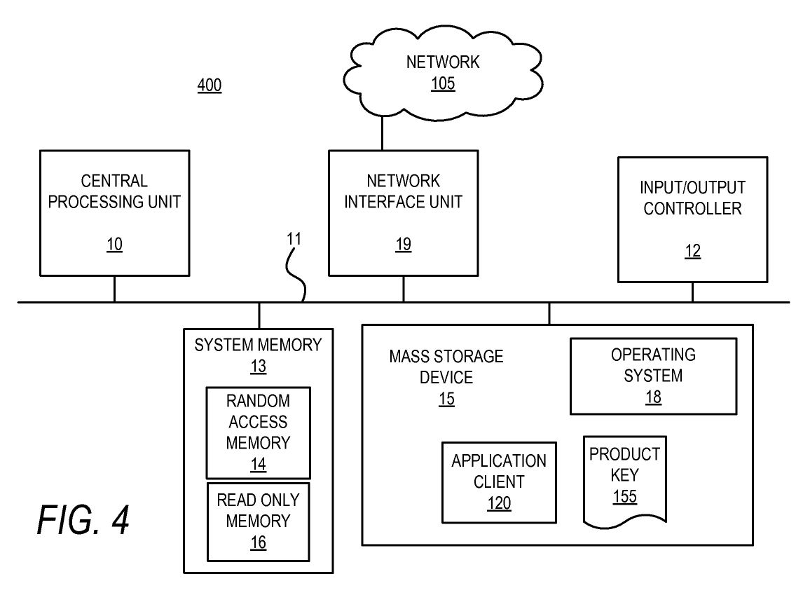

Turning now to FIG. 4, an illustrative computer architecture 400 can execute software components described herein for simplifying the purchase, licensing, delivery, installation, and activation of software products. The computer architecture shown in FIG. 4 illustrates a conventional desktop, laptop, or server computer and may be utilized to execute any aspects of the software components presented herein. It should be appreciated however, that the described software components can also be executed on other example computing environments, such as mobile devices, television, set-top boxes, kiosks, vehicular information systems, mobile telephones, embedded systems, or otherwise. Any one or more of the user system 115, the key distribution server 150, the application server 130, the authentication server 170, the activation server 160, and servers associated with the application vendor 140 may be implemented as computer systems 400 according to embodiments.

The computer architecture illustrated in FIG. 4 can include a central processing unit 10 (CPU), a system memory 13, including a random access memory 14 (RAM) and a read-only memory 16 (ROM), and a system bus 11 that can couple the system memory 13 to the CPU 10. A basic input/output system containing the basic routines that help to transfer information between elements within the computer 5, such as during startup, can be stored in the ROM 16. The computer 400 may further include a mass storage device 15 for storing an operating system 18, software, data, and various program modules, such as those associated with the application client 120. The application client 120 can execute portions of software components described herein. A product key 155 associated with the application client 120 may be stored on the mass storage device 15.

The mass storage device 15 can be connected to the CPU 10 through a mass storage controller (not illustrated) connected to the bus 11. The mass storage device 15 and its associated computer-readable media can provide non-volatile storage for the computer 5. Although the description of computer-readable media contained herein refers to a mass storage device, such as a hard disk or CD-ROM drive, it should be appreciated by those skilled in the art that computer-readable media can be any available computer storage media that can be accessed by the computer 400.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through a network such as the network 105. The computer 400 may connect to the network 105 through a network interface unit 19 connected to the bus 11. It should be appreciated that the network interface unit 19 may also be utilized to connect to other types of networks and remote computer systems. The computer 400 may also include an input/output controller 12 for receiving and processing input from a number of other devices, including a keyboard, mouse, or electronic stylus (not illustrated). Similarly, an input/output controller 12 may provide output to a video display, a printer, or other type of output device (also not illustrated).

As mentioned briefly above, a number of program modules and data files may be stored in the mass storage device 15 and RAM 14 of the computer 400, including an operating system 18 suitable for controlling the operation of a networked desktop, laptop, server computer, or other computing environment. The mass storage device 15, ROM 16, and RAM 14 may also store one or more program modules. In particular, the mass storage device 15, the ROM 16, and the RAM 14 may store the application client 120 for execution by the CPU 10. The application client 120 can include software components for implementing portions of the processes discussed in detail with respect to FIGS. 1-3. The mass storage device 15, the ROM 16, and the RAM 14 may also store other types of program modules. The mass storage device 15, the ROM 16, and the RAM 14 can also store a product key 155 associated with the application client 120 and other product keys associated with other applications.

Based on the foregoing, it should be appreciated that technologies for simplifying the purchase, licensing, delivery, installation, and activation of software products are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for managing software licenses, the method comprising:
storing a product key associated with an application client on a remote application server;
identifying user credentials using the application client;
retrieving the product key from the remote application server into the application client using a product identification and the user credentials; and
applying the product key to operate the application client.

2. The method of claim 1, wherein identifying user credentials comprises prompting a user to enter credentials to the application client.

3. The method of claim 1, wherein identifying user credentials comprises receiving credentials from a user into the application client.

4. The method of claim 1, wherein the product identification comprises a software product title associated with the application client.

5. The method of claim 1, wherein the product identification comprises a language associated with the application client.

6. The method of claim 1, further comprising activating the product key using a remote activation server.

7. The method of claim 6, wherein activating occurs as a background operation.

8. The method of claim 1, wherein storing the product key comprises obtaining the product key from a key distribution server in response to a request to purchase a software license.

9. A computer storage medium having computer executable instructions stored thereon which, when executed by a computer, cause the computer to:
initiate a purchase of a software license from an application vendor, the application vendor storing a product key associated with the software license on a remote application server;
identify user credentials; and
retrieve the product key from the remote application server using the user credentials.

10. The computer storage medium of claim 9, wherein identifying user credentials comprises prompting a user to enter credentials.

11. The computer storage medium of claim 9, wherein identifying user credentials comprises receiving credentials from a user.

12. The computer storage medium of claim 9, wherein retrieving the product key comprises providing a product identification to the remote application server.

13. The computer storage medium of claim 12, wherein the product identification comprises a software product title.

14. The computer storage medium of claim 12, wherein the product identification comprises a language.

15. The computer storage medium of claim 9, further causing the computer to activate the product key using a remote activation server.

16. The computer storage medium of claim 15, wherein activating occurs as a background operation.

17. A product license management system comprising:
a processing unit; and
an application client comprising one or more modules operable to cause the processing unit to prompt a user to enter user credentials, receive user credentials from a user, retrieve a product key from a remote application server using the user credentials, and activate the product key using a remote activation server.

18. The system of claim 17, wherein retrieving the product key comprises providing a product identification to the remote application server.

19. The system of claim 18, wherein the product identification comprises a software product title.

20. The system of claim 17, wherein activating occurs as a background operation.
